(19) United States
(12) Patent Application Publication
(10) Pub. No.: US 2007/0153355 A1
(43) Pub. Date: Jul. 5, 2007

(54) Electrochromic film

(75) Inventors: Lee-May Huang, Hsinchu (TW); In-Mau Chen, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/589,121

(22) Filed: Oct. 30, 2006

(30) Foreign Application Priority Data
Dec. 29, 2005 (TW) 94147224

(51) Int. Cl. G02F 1/15

(52) U.S. Cl. 359/265

(57) ABSTRACT

The present invention relates to an electrochromic film. The invention demonstrates the electrochromic effect of a single substrate film by applying electronic current to induce a reversible oxidation-reduction reaction of an organic electrochromic layer. The electrochromic film can attach to a surface of an object with the using of an adhesive layer.

### BACKGROUND OF THE INVENTION

1. Field of the Invention

The present invention relates to an electrochromic film and, more particularly, to an electrochromic film of single transparent plastic substrate.

2. Description of Related Art

The electrochromic mechanism involves in electrochromic materials, including organic and inorganic materials undergoes reversible oxidation-reduction reactions under an applied electrical current, and it accompanies with a material color change. Although, it is comprised with various electrochromic elements, the most common structure in the market is called surface confined thin film. According to the name, the feature of the electrochromic film provides with transition metal or an organic layer deposited on the surface of the electrode, comprises color-changed ability. When a driven voltage is applied on the electrochromic film, the thin layer comprises a redox reaction with the inputting and outputting of ions across electrochromic layer/electrolyte interface and the moving of the electrons for achieving electroneutrality. The synchronous redox reaction causes variations of the material wavelength absorption properties according to different applied voltage.

The electrochromic materials comprise inorganic metal oxide and organic material, the most common inorganic materials comprise WO₃, NiO and IrO₂, and the organic materials comprise conducting polymers, Viologens, metallopolymer and metallophthoyanines.

The mechanism of electrochromic elements is similar to batteries and it is a kind of chemical reaction. Take for example, the inorganic material WO₃, when the voltage is zero, the material appears to be transparent, but when a negative voltage is applied to the electrochromic element, the lithium ions are forced to enter the WO₃ layer and the original transparent WO₃ layer will then become darker; however, when an opposite polarity is applied, the lithium ions leave the WO₃ layer and the electrochromic layer will return to transparent state. From theoretical point of view, the protons input into the center of the WO₃ octahedral structure and change the color and the conducting properties of the material as the intercalation reaction occurs. Although inorganic electrochromic devices had been invented for decades, the production cost of the inorganic materials depositing processes are very high; moreover, since the performance of this kind of device is still far from satisfactory, the inorganic electrochromic device is still in lacks of significant market demands. In these recent years, with the improvement of organic electrochromic conducting materials, many studies have been done to replace the inorganic materials.

The traditional structure of electrochromic element comprises an upper and a lower layer of glass or plastic substrates. The two substrates comprise five coating layers with different functions that are sandwiched between the substrates, the structure of electrochromic element is similar to the structure of battery. Although the researches of electrochromic devices have been performed for many years, it is still far from ideal requirement as consumer goods. The process of depositing inorganic coating layers is very expensive, which makes it doesn't cost effective. Moreover, the glass substrate breaks easily, the colored-bleached quality is not good, the respond time is long and the device ageing easily into bronze color, which causes the application of inorganic electrochromic element not appealing. However, if the electrochromic element is produced on plastic substrate, and the organic materials are applied instead of inorganic materials, it will then be able to overcome the drawbacks of the glass electrochromic element. Nevertheless, the electrochromic film with two plastic substrates has the following drawbacks, such that some window glasses available in the market are curved in surface geometry and the two-plastic-substrate will de-laminate easily. Moreover, the electrochromic films with two-plastic-substrate lower the overall transparency, and increase the total thickness of the film. Hence, the purpose of the present development is to address a more practical electrochromic member, which can improve the applicability of electrochromic device.

### SUMMARY OF THE INVENTION

According to the drawbacks of the prior art, the object of the present invention is to provide an electrochromic film comprises with single plastic substrate, and improved transparency and stick-on property, especially on a surface that is not smooth and flat.

The other purpose of the present invention is to upgrade the applicability of electrochromic film and to make it attach more firmly on the surface of an object that is intended to have variations in light transmission across the object.

In order to achieve the objects, the present invention includes an electrochromic film, which is provided with an arrangement comprising: one transparent plastic substrate; an organic electrochromic conducting layer; a solid polymer electrolyte layer and an electrical conducting layer.

When a certain voltage is applied on the electrochromic film of the present invention, there is an instantaneous redox reaction occurring in the organic electrochromic layer, accompanying with the inputting and outputting of ions across the solid polymer electrolyte layer and the conducting layer to maintain electroneutrality. The synchronous redox reaction varies with the wavelength absorption property of the organic electrochromic-conducting layer. The electrochromic film of the present invention uses merely a single transparent plastic substrate, cooperates with electrical conducting layers which sandwiches an organic electrochromic layer and a solid polymer electrolyte layer thereof for achieving the effect of electrochromic performance.

Moreover, the electrochromic film of the present invention is further provided with an adhesive layer outside the electrical conducting layer, which makes the electrochromic film of the present invention combines with other materials and objects easily.

On the other hand, the present invention also discloses an electrochromic film, which is provided with an arrangement in order comprising: one transparent plastic substrate; an organic electrochromic conducting layer; a solid polymer electrolyte layer; and an organic electrical conducting layer, which is provided with at least one adhesive block. The electrochromic film comprises the adhesive layer and the organic conducting materials are formed in the same layer for reducing the numbers of the layer members in order to decrease the overall film thickness.

Furthermore, the organic electrochromic-conducting layer of the present invention is fabricated by a plurality of disconnected blocks for provided with pattern design of electrochromic effect.

Moreover, the electrochromic film of the present invention is able to achieve the electrochromic effect uniformly in large area by the use of electrical conducting circuitry and/or the use of electrical conducting layer.

The present invention reduces the numbers of the plastic substrates from two to one and still preserves the electrochromic effect. The electrochromic film of the present invention can attach to another object by the use of an adhesive layer. By using only one single plastic substrate and solid state components, it becomes easier for the electrochromic film to adhere to a flat or a curved object for the purpose of light control.

### BRIEF DESCRIPTION OF THE DRAWINGS

FIG. 1 is the structure of one embodiment of the electrochromic film of the present invention.

FIG. 2 shows the structure of electrochromic film of the present invention is provided with a conducting circuit structure.

FIG. 3 shows the specific structure of electrochromic film of the present invention is provided with a conducting circuit structure.

FIG. 4 shows the structure of electrochromic film of the present invention is provided with a transparent conducting layer.

FIG. 5A shows the electrochromic film of the present invention is provided with an organic conducting layer, which comprises a plurality of blocks.

FIG. 5B shows the structure of the single-color electrochromic film of the present invention.

FIG. 5C shows the structure of the double-colored electrochromic film of the present invention.

FIG. 6 shows the application of numeric display of the electrochromic film of the present invention.

FIG. 7 is the application design of the electrochromic film.

FIG. 8 is another application design of the electrochromic film.

FIG. 9 is the structure of another embodiment of the electrochromic film of the present invention.

FIG. 10A is the structure of the electrochromic film of the present invention, which comprises a stripe conducting layer.

FIG. 10B is the structure of the electrochromic film of the present invention, which comprises a net conducting layer.

### DETAILED DESCRIPTION OF THE PREFERRED EMBODIMENT

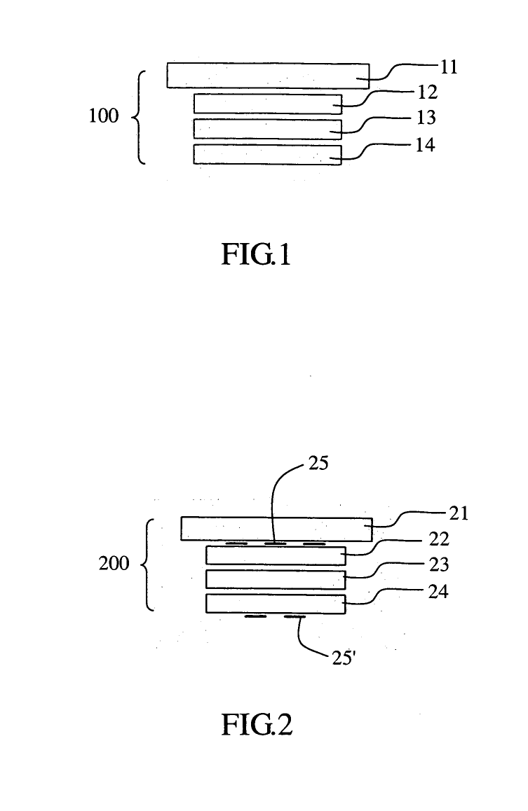

The structure of electrochromic film 100 of the present invention is as shown in FIG. 1 and it is constructed by the following members in order: a transparent plastic substrate 11; an organic electrochromic conducting layer 12; and a solid polymer electrolyte layer 13 and an electrical conducting layer 14. The transparent plastic substrates include but not limited to polyethyleneterephthatate, polycarbonate, cyclo olefin copolymers, polystyrene, polyacrylate, copolymers thereof or mixtures thereof; the material of organic electrochromic conducting layer 12 changes the light absorption property when subjected to a driven electrical potential. In the preferred embodiment, the present invention uses PEDOT as the electrochromic conducting material; however, it is well known in the art that other electrochromic conducting materials comprises PEDOT, polyaniline, polypyrrole, viologen or the mixture thereof are suitable as the materials for the organic electrochromic conducting layer of the present invention. Moreover, the organic electrochromic conducting materials further comprise a light absorbent, a light stabilizer, a temperature stabilizer or an antioxidant for extending the using life of the organic electrochromic conducting material.

The role of solid polymer electrolyte layer 13 of electrochromic film 100 of the present invention is for providing organic electrochromic conducting layer 12 the essential ions in order to maintain electroneutrality in a redox reaction. The materials comprise but not limit to PEO, PEG, PPO, PMMA, Lithium triflate, Lithium Perchlorate or the mixture thereof. The material has to be applied in a solid state, and it sandwiches the electrochromic conducting layer 12 with transparent plastic substrate 11 and forms a structure, an electrical conducting layer 14 is further applied on the electrolyte layer which generates electrochromism when a driven voltage is applied. The material of electrical conducting layer 14 includes organic or inorganic material. It is comprised but not limit to transparent metals, for example, silver, gold, aluminum, platinum, copper and metal oxides for example, Indium Tin Oxide, Indium Zinc Oxide, Al-doped ZnO, Antimony and the organic conducting materials, for example, PEDOT, polyaniline, polypyrrole or the mixture thereof. The conducting layer materials in some embodiments can be a material with electrochromic characteristic. In order to enhance the durability of electrochromic film, an extra ion storage layer can be inserted between layer 13 and layer 14. The solid electrolyte layer 13 then conducts ions back and forth between the electrochromic conducing layer 12 and an ion storage layer. The material of ion storage layer comprises V₂O₅, Ta₂O₅ or the mixture thereof. According to the known art in the filed: the arrangement of the ion storage layer between solid polymer electrolyte layer and electrical conducting layer is use for other electrochromic film 100 and the electrochromic film 200, 300 and 400 of the present invention mentioned later.

When the electrochromic film further comprises an adhesive layer, the electrochromic film 100 then can be pasted on the surface of other object and forming a stick-on electrochromic film.

When a driven voltage is applied to the electrochromic film 100, a self redox reaction will occur leading to electrochromic effect in the electrochromic conducting layer 12.

The electrochromic film of the present invention, wherein comprises the coating method and a structure of multi-layered coatings on a transparent plastic substrate. The applied coating method is well known in the art, which comprises roll coating, dip coating or screen-printing method.

In most embodiments of electrochromic films, there may happen that the applied current will concentrate mostly in the area close to the circuit and not being able to reach uniform distribution state. This situation can be solved by increasing additional electrical conducting wirings among conducting layers. The amounted position of the conducting circuits is as shown in FIG. 2, wherein that the FIG. 2 is a modified mode of the FIG. 1, it is provided with at least one conducting circuit 25 between the transparent plastic substrate 21 and the organic electrochromic conducting layer 22, and on the top of the organic conducting layer 24 comprises at least one conducting circuit 25′. When the conducting circuit 25 and the conducting circuit 25′ are driven with opposite electrical polarity the electrochromic effect in the organic electrochromic conducting layer 22 will uniformly expand across the whole film.

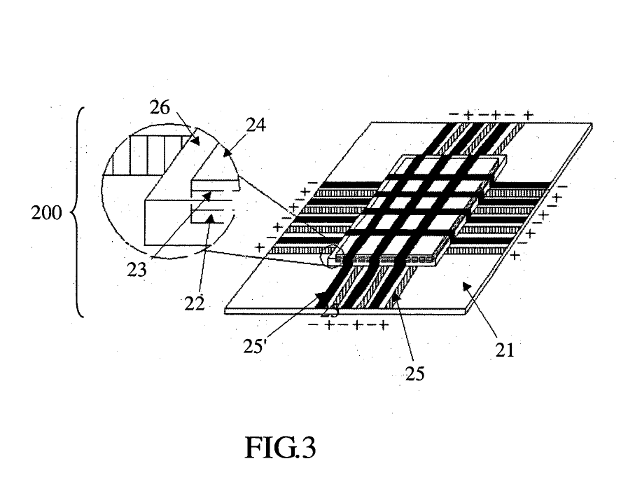

As shown in FIG. 2, the design of the conducting circuits makes possible the idea of large area electrochromic film with good electrochromic uniformity. The arrangement is applied in the electrochromic film 100 and 200 of the present invention, and the layout mode of the electrochromic circuit is not limited to lateral or cross mode of the conducting circuit 25 and 25′. More examples of the specific arrangement is as shown in FIG. 3. In FIG. 3, the conducting circuit 25 and 25′ are provided in cross mode, wherein that the conducting circuit 25 is mounted between the transparent plastic substrate 21 and the organic electrochromic conducting layer 22, and the conducting circuit 25′ is mounted on the organic conducting layer 24.

The selection of the conducting circuit material is known in the art, the preferred materials are transparent metals, for example, silver, gold, aluminum, platinum, copper, and metal oxides for example, Indium Tin Oxide, Indium Zinc Oxide, Al-doped ZnO, Antimony. Moreover, the electrochromic film of the present invention further comprises an insulation layer 26 in order to prevent unexpected shortage between the conducting circuit 25 and 25′.

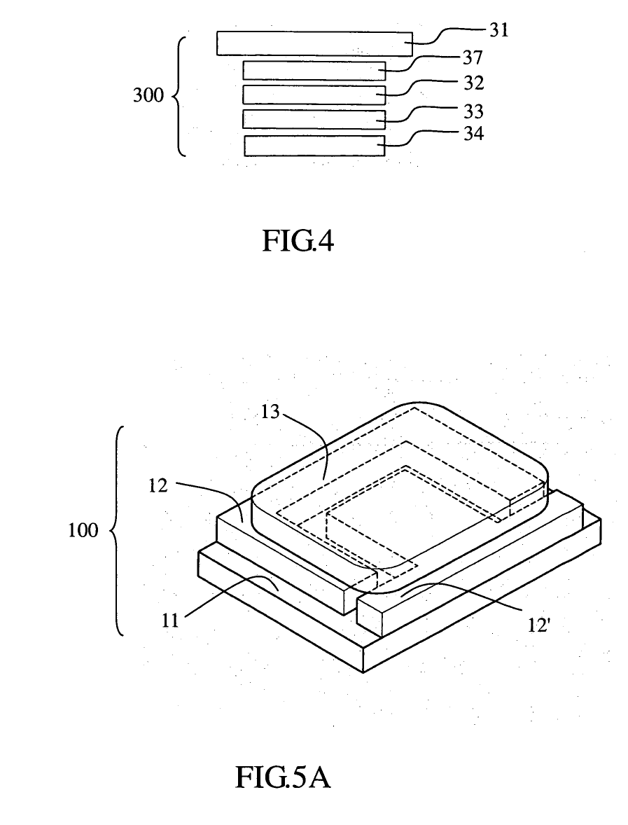

Besides of the design of the conducting circuit, the electrochromic film is able to raise the electrochromic effect of small organic molecules (for example, Viologen) by the following structure. It is shown in FIG. 4 that the electrochromic film 300 of FIG. 4 is provided with the same elements and orders as the electrochromic film 100, which comprises of a transparent plastic substrate 31, a solid polymer electrolyte layer 33 and an electrical conducting layer 34. When the material of the organic electrochromic layer 32 is an organic electrochromic material comprising smaller molecular weight, a transparent conducting layer 37 is mounted between the transparent plastic substrate 31 and the organic electrochromic layer 32 in order to improve the electrical conducting property of the layer structures of the electrochromic film 300. The material of the transparent conducting layer 37 can be transparent metals, for example, silver, gold, aluminum, platinum, copper and metal oxides for example, Indium Tin Oxide, Indium Zinc Oxide, Al-doped ZnO, Antimony, which is the transparent conducting material known in the art. The electrochromism occurs when the transparent conducting layer 37 is contacted to an electrode, and the electrical conducting layer 34 is connected to the other electrode with an opposite electrical polarity. The organic electrochromic layer 32 provides a self-redox accompanied by the inputting and the outputting of the ions across the solid electrolyte layer in order to maintain electroneutrallity. According to the known art in the filed: the arrangement of the transparent conducting layer between the transparent plastic substrate and the organic electrochromic layer is use for other electrochromic film 100, 200 and the electrochromic film 400 of the present invention mentioned later.

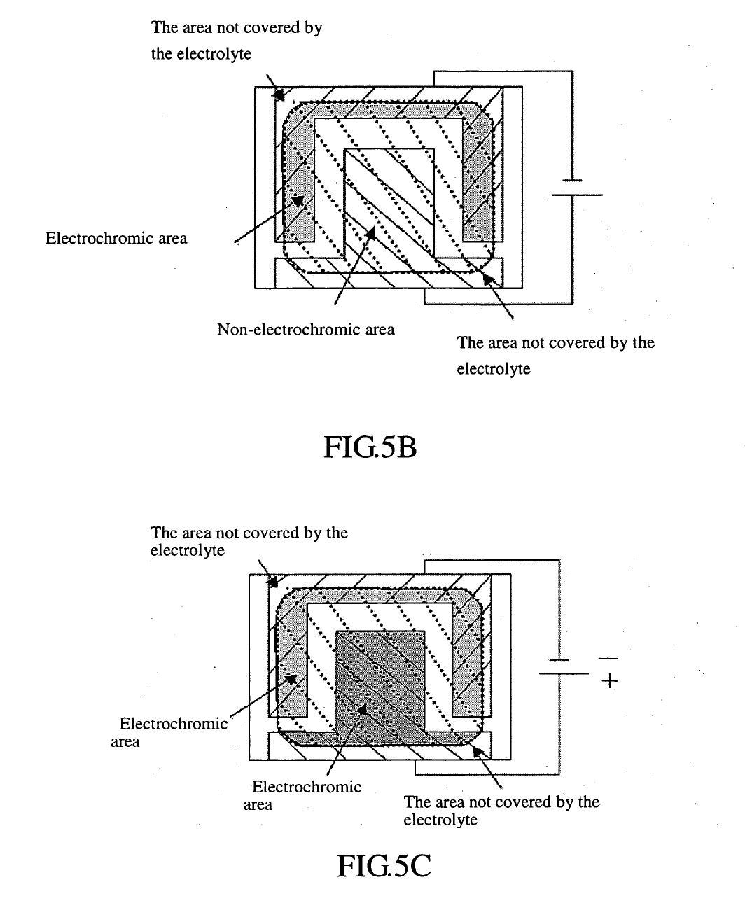

Furthermore, the electrochromic conducting layer of the present invention is further constructed by a plurality of disconnected blocks. The embodiment is shown in FIG. 5A, the embodiment is a modification from the FIG. 1, wherein the organic electrochromic conducting layer 12 is constructed by two disconnect blocks, 12 and 12′ which are both fully covered by a layer of solid electrolyte. When the two disconnected blocks are connected to two electrodes with opposite plurality, the block composing of cathodic electrochromic material will color immediately as shown in FIG. 5B. If the two blocks, 12 and 12′ of the organic electrochromic conducting layer 12 in FIG. 5C are constructed with different materials, which mean that one block material is the cathodic electrochromic material, whereas, the other block is anodic electrochromic material; both blocks will display electrochromic properties as they are electrically contacted.

In a preferred embodiment, the present invention also discloses an electrochromic film with single plastic substrate that provides an arrangement comprising: a transparent plastic substrate; an organic electrochromic conducting layer; a solid polymer electrolyte layer; and a layer comprising at least one adhesive block which are patterned in such a way that a “striped” or reticulated” electrical conducting wiring are designed to enable the electrochromic film to have both conducting and adhesion properties.

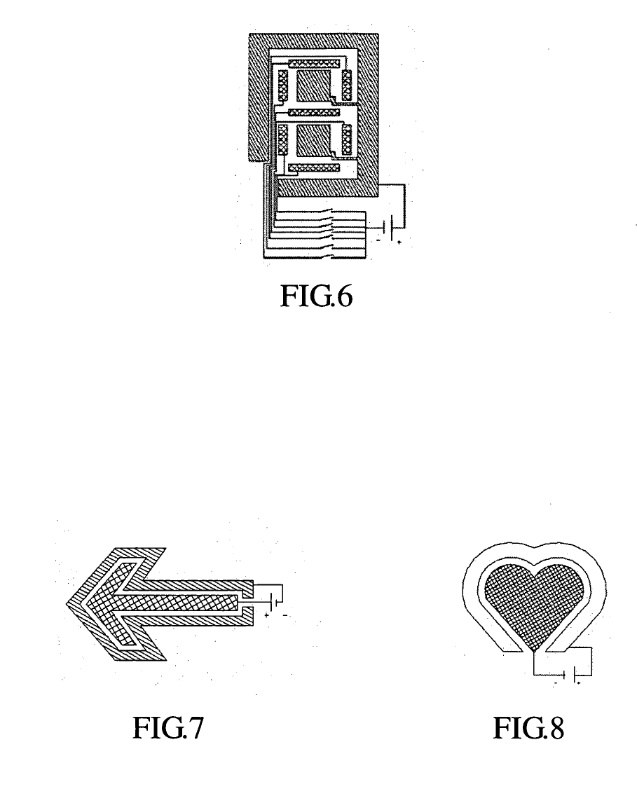

The FIG. 6 is to apply a design embodiment of the organic electrochromic conducting layer, which is constructed by a plurality of the multiple blocks. The organic electrochromic conducting layer forms a number “8” which is build up from seven segments,—the other block is built independently around the former number “8”, the two blocks are then fully covered with solid electrolyte layer as shown in FIG. 6. When the different wiring alignments of the seven segment blocks are contacted to an electrode and the outer block is further contacted to the other electrode with opposite polarity, the area of seven-segments will color immediately showing the number that is activated. Different numeric will be displayed as different wiring signals are inputted. The idea of utilizing disconnected blocks composing either one block or two blocks having electrochromic properties, can be applied as a single substrate electrochromic display which find applications as numeric display to compose figures such as product prices. Moreover, with the same concept, the disconnected blocks can be applied as direction sign or symbol sign, as shown in FIGS. 7 and 8, respectively.

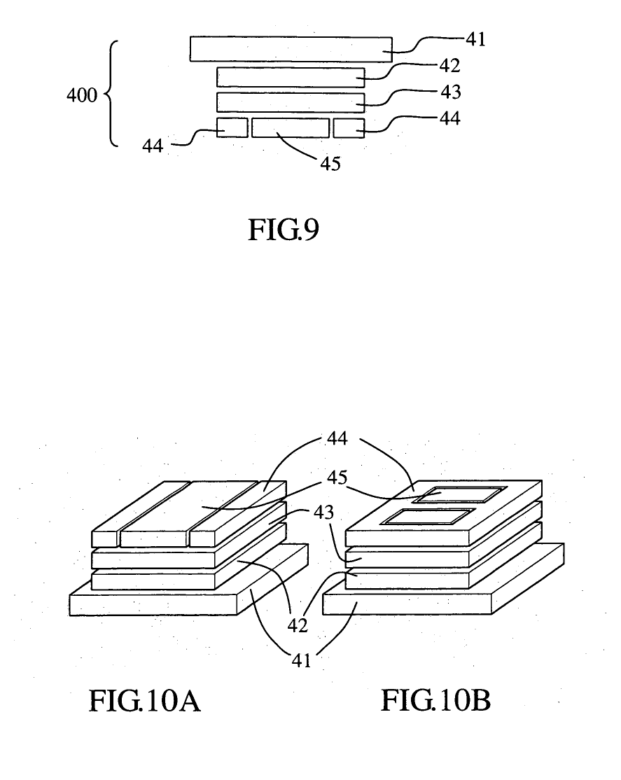

The electrochromic film 400 of another embodiment of the present invention is shown in FIG. 9, which is composed in order as follow by: the transparent plastic substrate 41; the organic electrochromic conducting layer 42; the solid polymer electrolyte layer 43; and stripes layers of an organic conducting layer 44 and adhesive block 45. The stripes design of the adhesive layer and the organic conducting materials formed together in the same layer will reduce the overall electrochromic film thickness. The present invention can be applied by screen printing and the stripe coating methods for forming the specific patterns of the adhesive and the organic conducting material on the same layer as shown in FIG. 10A or FIG. 10 B.

The following examples are used to further demonstrate the advantages of the present invention and to expand rather than limit its scope.

### EXAMPLE 1

### The Preparation of the Electrochromic Film of the Present Invention (I)

A layer of PEDOT/PSS coating was applied on a 5×6 cm² PET substrate which was then dried to form a transparent conducting layer. The solid polymer electrolyte was prepared as follows: 0.1 g lithium trifluomethanesulfonate and 1 g PEO were vacuum dried at 100° C. and 50° C. for 24 hours, respectively, The powders were then dissolved in 6 cc Propylene Carbonate solvent and stirred and heated to obtain a clear liquid electrolyte. The electrolyte was then coated on an area of 5×5 cm² PET conducting film, the rest 5×1 cm² was reserved as an electrode, the film was further dried in the vacuum oven at 120° C. for 8 hours. Next, a layer of PEDOT/PSS coating was coated on the top of the electrolyte layer and was dried in an oven at 100° C. for an hour. This layer would serve as the second electrode. When the electrochromic film was electrically connected with a driving force of 3 to 5 volts D.C. the area of 5×5 cm² turned immediately into the color of sky blue.

### EXAMPLE 2

### The Preparation of the Electrochromic Film of the Present Invention (II)

The PEDOT/PSS coating layer was designed as shown in FIG. 5A. The polymer electrolyte was prepared as follows: 0.05 g lithium trifluomethanesulfonate and 1 g PEO were dried respectively at 100° C. and 50° C. for 24 hours, then dissolved the powder in 6 cc THF solvent and stirred to obtain clear a liquid electrolyte. The electrolyte was then coated on the top of the specific pattern as shown in FIG. 5B which was then dried at the room temperature for 2 hours. When the electrochromic film was electrically connected with a driven voltage of 3 to 5 volts D.C., the cathodic electrochromic layer and the anodic electrochromic layer would color immediately.

### EXAMPLE 3

### The Preparation of the Electrochromic Film of the Present Invention (III)

A 4×4 cm² portion of 7.5×5 cm² PET substrate was coated with PEDOT/PSS coating which was then dried to form a transparent conducting layer. The solid polymer electrolyte was prepared as follows: 0.1 g lithium perchlorate and 1 g PMMA were vacuum dried at 100° C. and 50° C. for 24 hours, respectively, The powders were then dissolved in 10 cc Propylene Carbonate solvent and were stirred and heated to obtain a clear liquid electrolyte. An electrolyte thin layer of 4.5×3.5 cm² was then coated on top 4×3 cm² of PEDOT/PSS coating layer, the rest 4×1 cm² of the PEDOT/PSS coating were reserved as an electrode. The whole film was further dried in the vacuum oven at 120° C. for 8 hours.

A 20 nm thin layer of silver layer was sputtered on the top of the electrolyte layer and the bare part of PET substrate. In the RF magnetron sputtering process, care must be taken not to overlap the silver layer with PEDOT/PSS coating layer. The sputtering conditions were as follows: the sputter rate was 2 A°/sec in pure Argon gas environment. The applied power was 100 W. When cathodic PEDOT/PSS layer and anodic silver layer were electrically connected, the film would color immediately.

### EXAMPLE 4

### The Preparation of the Electrochromic Film of the Present Invention (IV)

Applied a electrochromic film prepared as described in Example 3. A thin layer of ITO was sputtered on the top of the electrolyte layer and the rest area of PET of the electrochromic film without overlapping with the PEDOT/PSS layer. The sputtering conditions were as follows: the vacuum pressure was 6×10⁻⁶ torr in Argon/Oxygen gas with ratio of 80:1, the sputter rate was 50 Angstrom/min and sputtering time was 10 min. The applied power was 100 Watt. When the alligator clips were connected to cathodic PEDOT/PSS layer and the anodic ITO layer of the electrochromic film, it would color immediately.

The electrochromic film of the present invention only needs one single substrate in order to achieve the effect of electrochromic, moreover, the film is able to stick directly on the surface of object by using an adhesive, and the electrochromic film of the invention can be applied as one single substrate electrochromic display by making use of the different patterns with distinct electrochromic effect.

### Other Embodiments

The preferred embodiments of the present invention have been disclosed in the examples. All modifications and alterations without departing from the spirits of the invention and appended claims, including the other embodiments shall remain within the protected scope and claims of the invention.

The preferred embodiments of the present invention have been disclosed in the examples. However, the examples should not be construed as a limitation on the actual applicable scope of the invention, and as such, all modifications and alterations without departing from the spirits of the invention and appended claims, including the other embodiments shall remain within the protected scope and claims of the invention.

What is claimed is:

1. An electrochromic film, which is provided with an arrangement in order comprising:
one transparent plastic substrate;
an organic electrochromic conducting layer;
a solid polymer electrolyte layer; and
an electrical conducting layer.

2. The electrochromic film of claim 1, wherein materials of said transparent plastic substrate comprise polyethyleneterephthatate, polycarbonate, cyclo olefin copolymers, polystyrene, polyacrylate, copolymers thereof or mixtures thereof.

3. The electrochromic film of claim 1, wherein materials of said organic electrochromic conducting layer comprises polyethylenedioxythiophene, polyaniline, polypyrrole, viologen or mixtures thereof.

4. The electrochromic film of claim 1, wherein said organic electrochromic conducting layer further comprises a light absorbent, a light stabilizer, a temperature stabilizer or an antioxidant.

5. The electrochromic film of claim 1, wherein materials of said solid polymer electrolyte layer comprises polyethylene oxide, polyphenylene oxide, polyethylene glycol, polypropylene glycol, polymethyl methacrylate, lithium triflate, lithium perchlorate or mixtures thereof.

6. The electrochromic film of claim 1, wherein materials of said electrical conducting layer comprises silver, gold, aluminum, platinum, copper, Indium Tin Oxide, Indium Zinc Oxide, Al-doped ZnO, Antimony Tin Oxide, polyethylenedioxythiophene, polyaniline, polypyrrole or mixtures thereof.

7. The electrochromic film of claim 1, wherein said electrical conducting layer further comprises an adhesive layer attached on said electrical conducting layer.

8. The electrochromic film of claim 1, wherein said organic electrochromic conducting layer fabricated by a plurality of disconnected blocks.

9. The electrochromic film of claim 1, wherein the electrochromic film further comprises at least one conducting circuit between said transparent plastic substrate and said organic electrochromic conducting layer and/or outside of said electrical conducting layer.

10. The electrochromic film of claim 1, wherein the electrochromic film further comprises a transparent conducting layer between said organic electrochromic conducting layer and said transparent plastic substrate.

11. The electrochromic film of claim 1, wherein the transparent conducting layer comprises silver, gold, aluminum, platinum, copper, Indium Tin Oxide, Indium Zinc Oxide, Al-doped ZnO, Antimony or mixtures thereof.

12. The electrochromic film of claim 1, wherein the electrochromic film further comprises an ion storage layer between said solid polymer electrolyte and said electrical conducting layer.

13. The electrochromic film of claim 12, wherein materials of said ion storage layer comprises NiO, V₂O₅, IrO₂ or mixture thereof.

14. An electrochromic film, which is provided with an arrangement in order comprising:
one transparent plastic substrate;
an organic electrochromic conducting layer;
a solid polymer electrolyte layer; and
an organic electrical conducting layer, which is provided with at least one adhesive block.

15. The electrochromic film of claim 14, wherein materials of said transparent plastic substrate comprises polyethyleneterephthatate, polycarbonate, cyclo olefin copolymers, polystyrene, polyacrylate, copolymers thereof or mixtures thereof.

16. The electrochromic film of claim 14, wherein materials of said organic electrochromic conducting layer comprises polyethylenedioxythiophene, polyaniline, polypyrrole, viologen or mixtures thereof.

17. The electrochromic film of claim 14, wherein said organic electrochromic conducting layer further comprises a light absorbent, a light stabilizer, a temperature stabilizer or an antioxidant.

18. The electrochromic film of claim 14, wherein materials of said solid polymer electrolyte layer comprises polyethylene oxide, polyphenylene oxide, lithium triflate, polyethylene glycol, lithium perchlorate or mixtures thereof.

19. The electrochromic film of claim 14, wherein materials of said electrical conducting layer comprises silver, gold, aluminum, platinum, copper, Indium Tin Oxide, Indium Zinc Oxide, Al-doped ZnO, Antimony Tin Oxide polyethylenedioxythiophene, polyaniline, polypyrrole or mixtures thereof.

20. The electrochromic film of claim 14, wherein said organic electrochromic conducting layer composed of disconnected blocks.

21. The electrochromic film of claim 14, wherein the electrochromic film further comprises at least one conducting circuit between said transparent plastic substrate and said organic electrochromic conducting layer and/or outside of said electrical conducting layer.

22. The electrochromic film of claim 14, wherein the electrochromic film further comprises a transparent conducting layer between said organic electrochromic conducting layer and said transparent plastic substrate.

23. The electrochromic film of claim 22, wherein the transparent conducting layer comprises silver, gold, aluminum, platinum, copper, Indium Tin Oxide, Indium Zinc Oxide, Al-doped ZnO, Antimony or mixtures thereof.

24. The electrochromic film of claim 14, wherein the electrochromic film further comprises an ion storage layer between said solid polymer electrolyte and said electrical conducting layer.

25. The electrochromic film of claim 14, wherein materials of said ion storage layer comprises NiO, V₂O₅, IrO₂ or mixture thereof.

26. An electrochromic film comprises one transparent plastic substrate, an organic electrochromic conducting layer, a solid polymer electrolyte layer and an electrical conducting layer, wherein said organic electrochromic conducting layer fabricated by a plurality of disconnected blocks.
